(19) United States
(12) Patent Application Publication
(10) Pub. No.: US 2024/0184329 A1
(43) Pub. Date: Jun. 6, 2024

(54) Device With Light-Shielding Structure

(71) Applicant: Apple Inc., Cupertino, CA (US)

(72) Inventors: Timon A. Wright, San Francisco, CA (US); Evan A. Cernokus, Campbell, CA (US)

(21) Appl. No.: 18/441,457

(22) Filed: Feb. 14, 2024

Related U.S. Application Data
(63) Continuation of application No. PCT/US22/41409, filed on Aug. 24, 2022.
(60) Provisional application No. 63/240,212, filed on Sep. 2, 2021.

(51) Int. Cl. G06F 1/16

(52) U.S. Cl. CPC G06F 1/163; G06F 1/1603

(57) ABSTRACT

A head-mounted device may have a main housing containing displays that display images to eye boxes for a user when the head-mounted device is worn by the user. The head-mounted device may include a light-shielding structure coupled to the main housing and configured to rest on the nasal region of the user. The light-shielding structure may include rigid members, flexible members, and/or fabric members. The light-shielding structure may conform to the facial features of the user around the nasal region to block environmental light from entering the eye boxes when the head-mounted device is worn by the user.

This application is a continuation of international patent application No. PCT/US2022/041409, filed Aug. 24, 2022, which claims priority to U.S. provisional patent application No. 63/240,212, filed Sep. 2, 2021, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may have a main housing unit and a nasal-region-mounted light-shielding structure coupled to the main housing unit. The light-shielding structure may include rigid members, flexible members, and/or fabric members.

The rigid and flexible members may define an outline or shape that conforms to the outline of the nasal region and closes gaps around the nasal region. By doing so, the light-shielding structure may be configured to block environmental light from entering an interior of the head-mounted device when the head-mounted device is worn on a user's head. The rigid members may be coupled to the main housing unit and support the flexible members in keeping a particular shape. The flexible members may deform differently to accommodate nasal region differences between different users while still closing gaps around the nasal regions. In some configurations, the fabric members may include a light-shielding fabric tented over the rigid and flexible members. As examples, the flexible members may be formed from elastomer layer, flexible arms, elastic cords, flexible fabric, or any other suitable flexible or elastic members.

### BRIEF DESCRIPTION OF THE DRAWINGS

FIG. 1 is a side view of an illustrative electronic device such as a head-mounted display device with a light-shielding structure in accordance with some embodiments.

FIG. 2 is a plan view of a head-mounted display device with a light-shielding structure for the nasal region in accordance with some embodiments.

FIG. 3 is a block diagram of an illustrative light-shielding structure formed from one or more rigid members, flexible members, and fabric members in accordance with some embodiments.

FIG. 4 is a plan view of an illustrative light-shielding structure having a light-shielding fabric tented over rigid and flexible members in accordance with some embodiments.

FIG. 5 is a cross-sectional side view of an illustrative portion of the light-shielding structure of FIG. 4 in accordance with some embodiments.

FIG. 6 is a perspective view of an illustrative light-shielding structure in accordance with some embodiments.

FIG. 7 is a diagram of an illustrative light shielding structure having a light-shielding fabric with a flexible region in accordance with some embodiments.

FIG. 8 is a top-down view of the illustrative light-shielding structure of FIG. 7 in accordance with some embodiments.

FIG. 9 is a diagram of an illustrative light-shielding structure having flexible arms and an elastic cord that close gaps around the nasal region in accordance with some embodiments.

### DETAILED DESCRIPTION

Head-mounted devices include head-mounted support structures that allow the devices to be worn on the heads of users. The head-mounted support structures may include device housings for housing components such as displays that are used for presenting a user with visual content. The head-mounted support structures for a head-mounted device may include a nasal-region-mounted support structure that rests on the nose of a user.

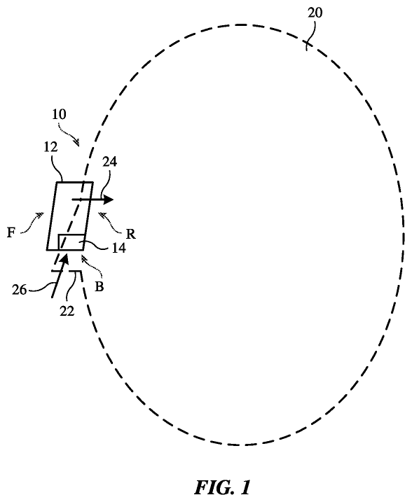

FIG. 1 is a side view of an illustrative head-mounted electronic device with a nasal region-mounted support structure. As shown in FIG. 1, head-mounted device 10 may include head-mounted housing 12 (sometimes referred to as a main housing, main housing unit, head-mounted support structure, etc.). Housing 12 may have walls or other structures that separate an interior housing region from an exterior region surrounding housing 12. For example, housing 12 may have walls formed from polymer, glass, metal, and/or other materials. Electrical and optical components may be mounted in housing 12. These components may include components such as integrated circuits, sensors, control circuitry, input-output devices, etc.

To present a user with images for viewing from eye boxes (e.g., eye boxes in which the user's eyes are located when device 10 is being worn on the user's head such as head 20 of FIG. 1), device 10 may include displays and lenses. These components may be mounted in optical modules or other supporting structure in housing 12 to form respective left and right optical systems. There may be, for example, a left display for presenting an image through a left lens to a user's left eye in a left eye box and a right display for presenting an image through a right lens to a user's right eye in a right eye box.

If desired, housing 12 may have forward-facing components such as cameras and other sensors on front side F for gathering sensor measurements and other input and may have a soft cushion on an opposing rear side R of housing 12. The rear side R of housing 12 may have openings that allow the user to view images (image light 24) from the left and right optical systems (e.g., when the rear side R of housing 12 is resting on the user's head 20).

If desired, device 10 may have an adjustable strap or headband, and if desired, may have other structures (e.g., an over-the-head strap) to help hold housing 12 on head 20.

As shown in FIG. 1, when worn by the user, device 10 may include a support structure such as support structure 14 that rests on the nasal region of head 20 (e.g., on nose 22). In particular, support structure 14 (sometimes referred to as a nasal-region-mounted support structure or a nasal-region-mounted structure) may serve as an extension of housing 12 that rests on nose 22 (along bottom side B and rear side R) and bridges between the opposing checks of the user. If desired, support structure 14 may be attached to housing 12 and/or may include one or more members formed from a portion of housing 12.

Support structure 14 may be configured as a light-shielding structure and may therefore be sometimes referred to as light-shielding support structure 14 or light-shielding structure 14. As an example, it may be desirable to enhance the viewing experience of the user by blocking external environmental light such as light 26 from entering the interior of device 10 (e.g., from entering the eye boxes) when device 10 is worn by the user. As such, support structure 14 may conform to the facial topology of the user around the nasal region and block light 26 from entering the eye boxes from the bottom side B of device 10. To this end, support structure 14 may be configured to close gaps around the nasal region of the user (e.g., gaps between the nose and checks of the user). In some illustrative configurations, support structure 14 may be adjustable to conform to varying facial topologies of different users (e.g., portions of support structure 14 may deform differently based on the nose shapes of the users).

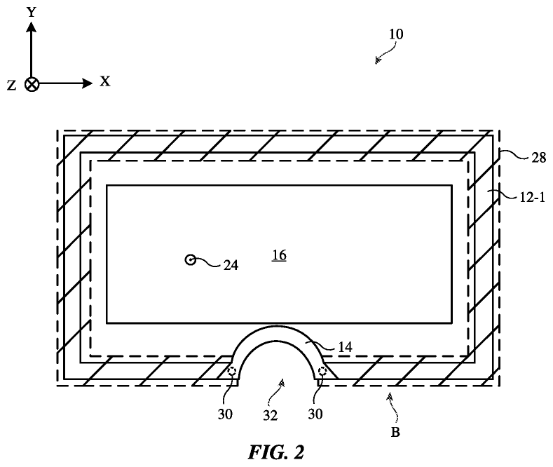

FIG. 2 is a plan view of a head-mounted display device having a main housing portion coupled to a nasal-region-mounted support structure. As shown in FIG. 2, the main housing portion (e.g., housing 12 in FIG. 1) may include a housing frame such as housing frame 12-1 (sometimes referred to as housing wall 12-1 or housing 12-1) that runs along the periphery of device 10. If desired, housing frame 12-1 may be overlapped by a cushion member on the rear side of the housing facing the user (e.g., on rear side R of device 10 in FIG. 1). As an example, the cushion member may include foam structures or other soft compressible structures affixed to housing frame 12-1. A fabric such as fabric 28 may overlap and extend over housing frame 12-1 and/or the cushion member on the rear side of the housing. If desired, fabric 28 may enclose only the cushion member, and the fabric-enclosed cushion member may be removably coupled to housing frame 12-1.

Light shielding structure 14 may be coupled to housing frame 12-1 along bottom side B of housing frame 12-1 via one or more coupling mechanism at other suitable locations such as coupling mechanisms 30 on opposing sides of structure 14. As examples, these coupling mechanisms may include magnets, adhesive, hinges, or any other suitable coupling mechanisms. Housing frame 12-1 may run completely along bottom side B such that a portion of housing frame 12-1 or other portion of the housing runs behind structure 14 in the +z direction as shown in FIG. 2 (see, e.g., FIG. 1).

In the example of FIG. 2, light shielding structure 14 is attached to housing frame 12-1 such that structure 14 is in front of housing frame 12-1 (in the −z direction as shown in FIG. 2). This is merely illustrative. If desired, housing frame 12-1, a cushion member, and/or fabric 28 may split into multiple portions to surround structure 14. As an example, fabric-enclosed cushion member may run in front of structure 14, and housing frame 12-1 may run behind structure 14. In general, the housing portions, cushion member, and/or fabric 28 may define an opening in which at light-shielding structure 14 is disposed.

In some illustrative examples, light-shielding structure 14 may be removably coupled (via magnetics) to housing frame 12-1 or other portions of the housing. In some illustrative examples, a portion of structure 14 may form an integral portion of housing frame 12-1 and/or may not be removable from the housing.

Light-shielding structure 14 may define or create an outline having opening 32 and other features along bottom side B of housing frame 12-1 that conform to the facial topology of the user around the nasal region when device 10 is worn by the user.

Housing frame 12-1 and support structure 14 (along with other structures) may define the periphery of the eye boxes of device 10 at which the user's eyes are located. Components 16 such as displays, lenses, sensors, etc., may overlap and/or be located within the eye boxes of device 10, and may be enclosed by and/or mounted to housing frame 12-1 and support structure 14. As illustratively shown in FIG. 2, a display may emit image light 24 through a lens to an eye box. Structure 14 may be configured to block environmental light from an exterior of device 10 from entering the eye box and interfering with image light 24.

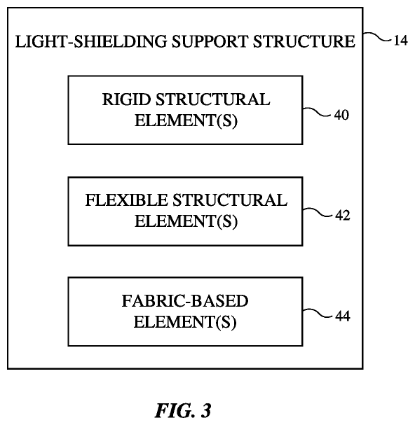

FIG. 3 is a block diagram of illustrative elements from which a light-shielding structure such as structure 14 is formed. As shown in FIG. 3, light-shielding structure 14 may include one or more rigid structural elements 40 (sometimes referred to as rigid members 40), one or more flexible structural elements 42 (sometimes referred to as flexible members 42), and one or more fabric-based elements 44 (e.g., fabrics or fabric members 44). If desired, one or more of these types of elements may be omitted in implementing light-shielding structure 14.

Rigid members 40 may form a rigid frame that provides support for other elements of light-shielding structure 14 and may define the general outline of light-shielding structure 14. As examples, rigid members 40 may be formed from metal, plastic, polymer, composite materials, and/or any other suitable rigid materials. In some illustrative configurations, housing 12-1 (FIG. 2) may be coupled to support structure 14 (via mechanisms 30) at locations on one or more rigid members 40. If desired, one or more rigid members 40 may be implemented as an integral portion of housing wall 12-1 or another portion of the housing.

Flexible members 42 may be attached to and/or extend between rigid members 40. Flexible members 42 (along with rigid member 40) may further define the general outline of light-shielding structure 14. In particular, flexible members 42 may help close gaps in the general outline of light-shielding structure 14 such that structure 14 may serve as an effective light-shielding structure (e.g., in combination with a light-shielding member). In some configurations, flexible members 42 may provide flexibility and adjustability for differences in facial topography and features between different users. As an example, flexible members 42 may deform in different manners based on the facial topography of different users, thereby allowing light-shielding structure 14 to accommodate a wide variety of users (e.g., cach having a nose shape). As an example, flexible members 42 may be formed from an elastic polymer or elastomer or any other suitable flexible or elastic materials. These materials may form flexible fabric portions, flexible arms, clastic cords, flexible layers, or other flexible structures that implement flexible members 42.

In some illustrative configurations in which light-shielding structure 14 includes rigid and flexible members, structure 14 may be configured such that the flexible members and not the rigid members are pressed against the user's face (e.g., nose) when device 10 is worn by the user. In other words, one or more flexible members may cushion the user's face from one or more rigid members 40 when device 10 is worn by the user.

Fabric members 44 may include may serve as a light-shielding member or layer for light-shielding structure 14. In particular, illustrative configurations in which fabric member 44 is a fabric cover (sometimes referred to as a fabric cover layer or a cover layer) are described herein as an illustrative example. To serve light-shielding functions, the fabric cover may be formed from an opaque or light-shielding material (e.g., black yarn) or may formed from an underlying material coated with an opaque or light-shielding material (e.g., black dye or ink). As examples, the fabric cover may be formed any suitable type of fabric such as knit fabric, woven fabric, braided fabric, etc. In some configurations, the fabric cover may extend around members 40 and 42 and may be tented over the structure of members 42 and 44 such that the fabric cover takes on the outline of the structure imparted by members 42 and 44 and serves as a cosmetic cover layer.

Tenting of the fabric cover over an underlying structure (e.g., formed from members 40 and 42) may be achieved by the underlying structure contacting or otherwise supporting the fabric cover at one or more points or areas of support as the fabric cover extends over one or more sides of the underlying structure. The tenting of the fabric cover over the underlying structure may cause the fabric cover to follow the general outline of the underlying structure, especially around the areas of support. If desired, differences in the outlines of the fabric cover and of the underlying structure may exist, especially in some regions away from the areas of support, thereby causing some portions of the fabric cover to be suspended in air and therefore readily deflectable. As an example, the fabric cover may be deflectable to the boundary of the underlying structure (or even beyond the boundary of the underlying structure if the boundary is defined by a flexible or deformable member such as member 42).

In such a way, the fabric cover may have a three-dimensional shape (based on an outline of the underlying structure) that includes portions (e.g., directly supported by the underlying structure) that are more defined and portions (e.g., not directly supported by the underlying structure, suspended in air, etc.) that are less defined, and more flexible or yielding. These less-defined portions (e.g., a yielding fabric surface) may help form flexible boundaries such as those for an opening configured to receive a user's nose.

As a particular illustrative example, the underlying structure may have surfaces that define an opening for accommodating a user's nose. The surfaces may be surrounded by peripheral edges. The fabric cover may be tented over the underlying structure such that the fabric cover is directly supported by the underlying structure along one or more of the peripheral edges of the underlying structure and may be suspended in air around the opening, thereby providing a fabric surface that is deflectable by the user's nose. This may help with improving user comfort as well as providing a more conformal fit when the light shielding structure rests on the user's nose.

In some illustrative configurations, the tenting of the fabric cover may extend over all sides of the underlying structure to cover the underlying structure entirely, and the fabric cover may have opposing edges that meet along a single seam running along one or more edges of the underlying structure. In some illustrative configurations, the tenting of the fabric cover may extend over only some of the sides of the underlying structure, leaving the remaining sides exposed (e.g., not overlapped by the fabric cover).

The underlying structure (e.g., formed from members 40 and 42), over which the fabric cover is tented, may have any suitable shape or structure. As examples, the underlying structure may be a structure having a three-dimensional shape with a well-defined outer surface, may be a frame structure having an outline roughly defined by a collection of points or segments, may be a frame having a single non-overlapping layer of structure, may be a frame having multiple overlapping layers of structure, etc. Because the underlying structure provides the general internal structure or framework for light-shielding structure 14 while the fabric cover covering the underlying structure actually defines the external surface of light-shielding structure 14, the underlying structure may sometimes be referred to as a skeletal structure. In other words, the underlying structure serves as the internal support framework or skeleton for light-shielding structure 14.

If desired, fabric members 44 may be or include other fabric-based elements. As examples, fabric members 44 may include a flat knit fabric structure having flexible portions and rigid portions or other fabric structures incorporated non-fabric components.

If desired, fabric members 44 may provide structural functionalities (similar to rigid members 40) and adjustability functionalities (similar to flexible members 42) in addition to light-shielding functions.

These elements for light-shielding structure 14 are merely illustrative. If desired, one or more of these members 40, 42, and 44 may be omitted, and the functionalities may be combined and imparted by a single type of functional member. If desired, light-shielding 14 may include any other suitable elements.

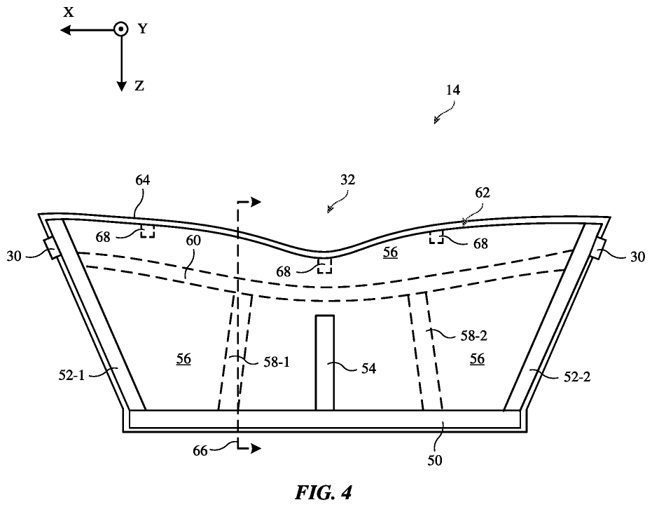

FIG. 4 is a plan view of an illustrative light-shielding structure for implementing light-shielding structure 14. As shown in FIG. 4, support structure 14 may include a rigid frame (sometimes referred to as a rigid structure or a rigid member) having rigid portions 50, 52-1, 52-2, and 54. Rigid frame portions 50, 52-1, and 52-2 may be disposed along three respective peripheral edges of light-shielding structure 14. These three peripheral edges may face away from the user, while edge 62 faces the user, when light-shielding structure 14 rests on the user's face. Rigid frame portion 54 may extend along the central portion of light-shielding structure 14 and partially across the z-dimension of light-shielding structure 14. If desired, rigid frame portion 54 may extend entirely across the z-dimension of light-shielding structure 14 to reach edge 62.

In the example of FIG. 4, frame portions 52-1 and 52-2 may include recesses or other elements to which coupling mechanisms 30 such as magnets are attached. Accordingly, the main housing unit (e.g., housing wall 12-1 in FIG. 2) may be attached to light-shielding structure 14 via coupling mechanisms 30 and rigid frame portions 52-1 and 52-2. The location and type of coupling mechanisms 30 for coupling light-shielding structure 14 to the housing are merely illustrative. If desired, other coupling or attachment mechanisms at other locations may be used in additional to or instead of attachment mechanisms 30 at rigid frame portions 52-1 and 52-2.

A layer of flexible or elastic material such as layer 56 may span the area between rigid frame portions 50, 52-1, 52-2, and 54 and may extend to and define peripheral edge 62 of light-shielding structure 14. Configurations in which layer 56 is formed from an elastomer or other suitable flexible polymer are described herein as illustrative examples. If desired, elastomer layer 56 may have a thickness of greater than 0.1 mm, greater than 0.25 mm, greater than 0.5 mm, about 1 mm, less than 2 mm, less than 5 mm, etc.

Configured in this manner, the rigid frame portions of light-shielding structure 14 may provide support for layer 56 to retain the desired outline for light-shielding structure 14, while layer 56 may extend along edge 62 and between the rigid frame portions to define opening 32 for flexibly conforming to the outline of the user's nose.

As shown in FIG. 4, a fabric cover such as fabric cover 64 may be tented over the rigid frame and layer 56. In particular, the tenting of fabric cover 64 over the rigid frame and layer 56 may be achieved by the rigid frame and/or layer 56 supporting or contacting fabric cover 64 along one or more points, segments, edges, surfaces, etc., (e.g., along one or more of the peripheral segments such as frame portions 52-1 and 52-2, layer 56 along edge 62, etc.). In such a manner, portions of fabric cover 64 away from these areas of support (e.g., around opening 32) may be suspended in air and readily deflectable (e.g., when opening 32 receives the user's nose).

Fabric cover 64 may be an opaque light-shielding fabric that covers and conceals the rigid frame and layer 56 from view. The opaque light-shielding appearance of light shielding structure 14 may be imparted by opaque fabric cover 64. Configured with an opaque fabric cover, light-shielding structure 14 may block environment light (e.g., light 26 in FIG. 1) from entering into the eye boxes from around the nasal region when device 10 is worn by the user.

While fabric cover 64 is shown in FIG. 4 to run around the peripheral edges of support structure 14, fabric cover 64 actually extends across the x-z plane in FIG. 4 to conceal the rigid frame portions and layer 56 when viewing in the both the +y and −y directions. The interior structures such as the rigid frame portions and layer 56 have been revealed for the sake of clarity and description.

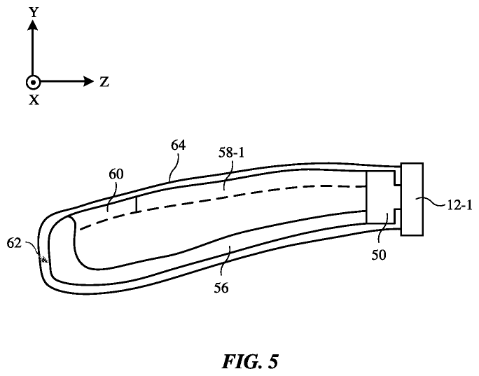

FIG. 5 shows an illustrative cross-sectional view of the light-shielding structure 14 of FIG. 4 taken along dashed line 66 in FIG. 4. As shown in FIG. 5, elastomer layer 56 extends from frame portion 50 along one edge of support structure 14 to the opposing edge 62 of support structure 14. Fabric cover 64 may extend from top side of frame portion 50, around layer 56, and to the bottom side of frame portion 50. In the example of FIG. 5, the two ends of layer 56 may be affixed along the same edge of frame portion 50 (facing housing frame 12-1). Any suitable coupling mechanisms may be used to attach the two ends of layer 56 to frame portion 50 or any other portion of support structure 14 and/or housing 12-1. In such a manner, fabric cover 64 may be tented over the top and bottom surfaces (e.g., in the x-z plane) of the rigid frame and elastomer layer 56. Elastomer layer 56 may help retain and support the shape of fabric cover 64. Fabric cover 64 may also be tented over other portions of elastomer layer 56 and frame portions 52-1, 52-2, and 54 (in other cross-sectional views of FIG. 4) in a similar manner. The two ends of fabric cover 64 may be affixed to frame portions 52-1, 50, and/or 52-2 along the peripheral edges facing the main housing unit (e.g., housing wall 12-1).

Configurations in which elastomer layer 56 and the rigid frame extend in a non-overlapping manner across a single non-overlapping layer of structure, over which fabric cover 64 is tented, are merely illustrative. If desired, light-shielding structure 14 may include additional rigid portions and/or flexible portions that overlap elastomer layer 56 to provide multiple overlapping layers of structure over which fabric layer 64 is tented. In particular, as shown in FIG. 5, additional structural portions 58-1 and 60 extend from one edge of light-shielding structure 14 toward opposing edge 62 along a first (top) layer of structure, while elastomer layer 56 may extend from the one edge of light-shielding structure 14 toward opposing edge 62 along a second (bottom) layer of structure. Portions 58-1 and 60 may connect to elastomer layer 56 to form a multi-layer structure over which fabric cover 64 is tented.

Referring back to FIG. 4, light-shielding structure 14 may include additional structural portions 58-1 and 58-2 that extend from frame portion 50 on either side of the central portion (along which frame portion 54 extends). Additional structural portion 60 may connect the ends of structural portions 58-1 and 58-2 opposite the ends connected to frame portion 50 and extend between frame portions 52-1 and 52-2. In a similarly manner shown in FIG. 5, structural portions 58-1, 58-2, and 60 may all run above layer 56 (e.g., in the +y direction). Elastomer layer 56 may wrap around along edge 62 to connect to structural portion 60 along edge 62 (sec, e.g., FIG. 5). As an example, structural portions 58-1, 58-2, and 60 may form an integral portion of the rigid frame. If desired, light-shielding structure 14 may include structural portions 58-1, 58-2, and 60 and omit frame portion 54.

In some illustrative configuration in which light-shielding structure 14 includes rigid frame portions 58-1, 58-2, and 60 across the top layer of structure, elastomer layer 56 across the bottom layer of structure may have cutouts that provide venting across support structure 14. As an example, similar to elongated frame portions 58-1 and 58-2 in the top layer, elastomer portions in the bottom layer may also include elongated portions that run from frame portion 50 toward edge 62. Configured in this manner, elongated rigid frame portions and elongated elastomer portions may form a three-dimensional skeletal structure (frame) of rigid and flexible structures over which fabric cover 64 is tented. In this configuration, elastomer layer 56 may still include the wrap-around portion that runs along edge 52 between frame portions 52-1 and 52-2. If desired, elastomer layer 56 may include cutouts 68 along edge 62 may be used to help support structure 14 to improve compliance to facial features around the nasal region.

These examples described in connection with FIGS. 4 and 5 are merely illustrative. If desired, the rigid frame may take on any suitable shape, and the elastomer layer may extend between the rigid frame and have any suitable cutouts or openings that improve compliance and/or venting. If desired, the rigid frame, the elastomer layer, and/or other members may collectively define a non-overlapping single layer of skeletal structure or a multi-layer skeletal structure, over which the fabric cover is tented.

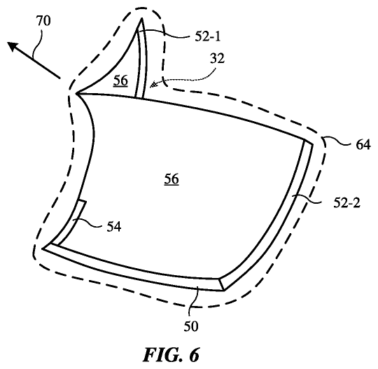

FIG. 6 is a perspective view of an illustrative light-shielding structure having a single layer of structure over which an opaque fabric layer is tented. As shown in FIG. 6, layer 56 may include two concave portions joined along the center portion along which frame portion 54 is disposed. The two concave portions may curve to define opening 32 for receiving the user's nose. Because layer 56 lining the top edge of light-shielding structure 14 is flexible or clastic, layer 56 may be deform to accommodate for different users having different facial topologies around the nasal region. As an example, different portions of layer 56 may be pushed in direction 70 or other directions away from the user to varying degrees depending on the facial topology of the user. Fabric cover 64 may be tented over and cover the rigid frame and layer 56.

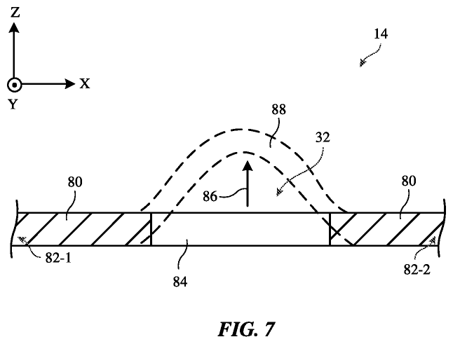

FIG. 7 is a diagram of a nasal-region-mounted light-shielding structure that includes a flexible fabric region configured to receive a user's nose. As shown in FIG. 7, light-shielding structure 14 may include a fabric having portions 80 and 84. The fabric may include opposing ends 82-1 and 82-2 respectively coupled corresponding portions of the housing (e.g., housing wall 12-1 in FIG. 2). If desired, ends 82-1 and 82-2 may be coupled other rigid frame members for light-shielding structure 14.

Portion 80 of the fabric may form the structural regions, while portion 84 may form the stretchy or flexible regions of the fabric. In other words, portion 80 may be stiffer or more rigid than portion 84. As such, portion 84 may be configured to deform in direction 86 to position 88 (thereby creating opening 32 for a user's nose), when the fabric of support structure 14 rests on the user's nose.

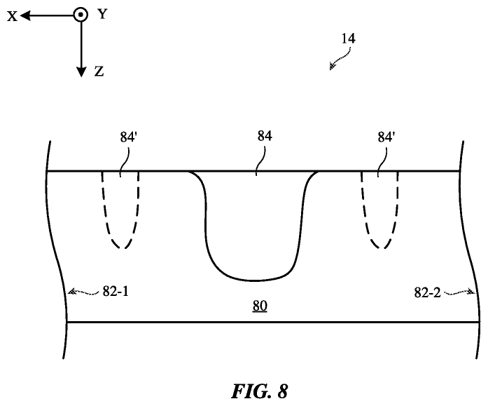

FIG. 8 is a top-down view of the light-shielding structure of FIG. 7. As shown in FIG. 8, stretchy fabric region 84 may be surrounded by structural fabric region 80. As such, the deformation of support structure 14 (when interacting with the user's facial features) may be controlled by the shape and size of stretchy fabric region 84, which deforms more readily than structural fabric region 80. If desired, the fabric of support structure 14 may include additional flexible fabric regions 84′ to further control the deformation of fabric layer 14 (e.g., improve compliance in accommodating the user's nose).

As an example, regions 80 and 84 may be formed from a single piece of fabric such as a knit fabric, a woven fabric, or any other suitable fabric. Configurations in which the integral fabric is a knit fabric are described herein as illustrative examples. If desired, the fabric may be formed using fusible yarn, thermoplastic polyurethane (TPU) yarn, or any other suitable types of yarn, or any other type of fabric material.

If desired, the rigidity or stiffness of region 80 relative to region 84 may be adjusted by incorporating rigid or structural elements within the portions of the fabric defining portion 80 or by otherwise attaching rigid or structural elements to the fabric. As an example, the fabric may be knit, woven, or otherwise formed with pockets in region 80, and different rigid or structural elements may be placed within the pockets to define the rigidity or stiffness of region 80.

If desired, the fabric may have variable density. For example, the fabric layer may be a variable density knit fabric, where the higher density regions may form stiffer portion 80 and the lower density regions may form the more flexible portion 84. If desired, portion 80 and/or 84 may be formed from non-fabric structures such as elastomer structures, rigid structures, etc.

In the configurations described in connection with FIGS. 7 and 8, the fabric may itself serve as a light-shielding layer (e.g., formed from light-shielding materials, knit or otherwise formed to close gaps in the fabric, etc.) to prevent environmental light from entering the eye boxes from the nasal region when light-shielding structure 14 rests on the user's nose. If desired, an additional fabric cover such as an opaque fabric cover (e.g., fabric cover 64 in FIG. 4) may be tented over and cover the fabric of FIGS. 7 and 8.

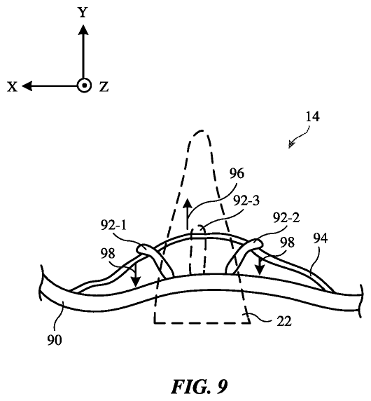

FIG. 9 is a diagram of an illustrative nasal-region-mounted light-shielding structure having flexible members (e.g., elements 42 in FIG. 3) implemented using one or more flexible arms and an elastic cord. As shown in FIG. 9, light-shielding structure 14 may include a rigid member 90 (e.g., element 40 in FIG. 3). If desired, rigid member 90 may form a portion of the housing (e.g., may form a portion of housing wall 12-1 in FIG. 2). Flexible or movable arms 92-1 and 92-2 may be attached to and extend from rigid member 90. The points of attachment of arms 92-1 and 92-2 at member 90 may serve as points on which flexible arms 92-1 and 92-2 pivot. As an example, the distal ends of arms 92-1 and 92-2 may move in the +y and −y directions.

An elastic cord such as cord 94 may extend from a first peripheral point on rigid member 90 to a second peripheral point on rigid member 90. Cord 94 may extend through respective openings in arms 92-1 and 92-2. Cord 94 and arms 92-1 and 92-2 may thereby move interdependently (e.g., when cord 94 moves in a direction, arms 92-1 and 92-2 may also move in the direction). An opaque light-shielding fabric cover (e.g., fabric cover 64 in FIG. 4) may be tented over and cover arms 92-1 and 92-2, cord 94, and/or rigid frame 90 to configure structure 14 as a light-shielding structure.

As an example, when device 10 incorporating light-shielding structure 14 of FIG. 9 is worn on the user's head, light-shielding structure 14 may rest on the user's nose. This may cause the center portion of cord 94 to be pulled in direction 96 to accommodate the user's nose.

In configurations in which arms 92-1 and 92-2 are omitted, the entirety of cord 94 may stretch upward (in direction 96) along with the tented fabric layer, causing gaps around the nasal region, which are uncovered by light-shielding structure 14 and through which environmental light can undesirably leak into the eye boxes of device 10 when worn by the user. Arms 92-1 and 92-2 may help hold peripheral portions of cord 94 down (e.g., by exerting force in direction 98). This may help keep the peripheral portions of cord 94 and the tented fabric layer in place to close any undesired gaps.

If desired, one or more additional flexible arms such as flexible arm 92-3 or other structures may extend from frame 90. Elastic cord 94 may also extend through an opening in arm 92-3. Similar to arms 92-1 and 92-2, arm 92-3 may also help limit the movement of cord 94 in order to retain a desirable outline for the tented fabric layer to perform satisfactory light-shielding functions for light-shielding structure 14. If desired one or more of arms 92-1, 92-2, and 92-3 may be omitted.

Personally identifiable information may be used by one or more devices or systems described herein. Accordingly, the use of personally identifiable information should comply with privacy guidelines generally recognized as meeting or exceeding industry or governmental requirements for maintaining the privacy of users. Generally, the purpose of the use should be clearly indicated to users, and personally identifiable information should be handled to minimize risks of unintended or authorized access or use.

In accordance with an embodiment, a head-mounted device is provided that includes a housing, displays disposed in the housing and configured to display images to eye boxes, and a light-shielding structure having a rigid frame, an elastic structure extending from the rigid frame, and a fabric cover supported by and extending over the rigid frame and the elastic structure.

In accordance with another embodiment, the rigid frame includes a portion that extends along a peripheral edge of the light-shielding structure and the elastic structure includes an elastomer layer that extends from the portion of the rigid frame toward an opposing edge of the light-shielding structure.

In accordance with another embodiment, the rigid frame includes additional portions that extend along additional peripheral edges of the light-shielding structure, and the elastomer layer extends between the additional portions of the rigid frame.

In accordance with another embodiment, the rigid frame includes an additional portion that extends from the portion of the rigid frame along a central portion of the light-shielding structure, and the elastomer layer includes portions that extend from the rigid frame toward the opposing edge of the light-shielding structure on opposing sides of the central portion.

In accordance with another embodiment, the fabric cover includes an opaque fabric cover.

In accordance with another embodiment, the elastomer layer defines an opening configured to receive a nose.

In accordance with another embodiment, the elastomer layer is configured to deform based on an outline of the nose.

In accordance with another embodiment, the rigid frame and the elastic structure form an underlying structure over which the fabric cover is tented.

In accordance with another embodiment, the rigid frame and the elastic structure define a non-overlapping layer over which the fabric cover is tented.

In accordance with another embodiment, the elastic structure includes a flexible arm that extends from the rigid frame and an elastic cord that extends through the flexible arm and has opposing ends coupled to the rigid frame.

In accordance with another embodiment, the elastic structure includes an additional fabric having a stretchy region surrounded by a structural region that is stiffer than the stretchy region.

In accordance with another embodiment, the rigid frame is formed from a portion of the housing.

In accordance with another embodiment, the rigid frame is attached to the housing and the light-shielding structure at least partly defines an outline of the eye boxes and is configured to block external environmental light from entering the eye boxes when the head-mounted device is worn.

In accordance with an embodiment, a head-mounted device is provided that includes a housing, displays disposed in the housing and configured to display images to eye boxes, and a nasal-region-mounted light-shielding structure with first and second opposing sides, the nasal-region-mounted light-shielding structure includes a rigid structure at the first side that is coupled to the housing, a flexible structure that extends along the second side and is configured to define an adjustable opening that receives a nose, a cover layer that covers the flexible structure.

In accordance with another embodiment, the flexible structure includes a polymer layer and the cover layer includes an opaque fabric cover.

In accordance with another embodiment, the nasal-region-mounted light-shielding structure has first and second opposing surfaces that connect the first side to the second side and the cover layer extends across the first and second surfaces and around the second side.

In accordance with another embodiment, the flexible structure includes an elastic cord that is coupled to the rigid structure via a flexible arm.

In accordance with an embodiment, a head-mounted device is provided that includes a housing, displays disposed in the housing and configured to display images to eye boxes, and a fabric coupled to the housing and having a flexible region that is configured to deform to receive a nose.

In accordance with another embodiment, the fabric includes a flat knit fabric.

In accordance with another embodiment, the fabric has a structural region that surrounds the flexible region and is stiffer than the flexible region.

The foregoing is merely illustrative and various modifications can be made to the described embodiments. The foregoing embodiments may be implemented individually or in any combination.

What is claimed is:

1. A head-mounted device comprising:
a housing;
displays disposed in the housing and configured to display images to eye boxes; and
a light-shielding structure having a rigid frame, an elastic structure extending from the rigid frame, and a fabric cover supported by and extending over the rigid frame and the elastic structure.

2. The head-mounted device defined in claim 1, wherein the rigid frame includes a portion that extends along a peripheral edge of the light-shielding structure and wherein the elastic structure comprises an elastomer layer that extends from the portion of the rigid frame toward an opposing edge of the light-shielding structure.

3. The head-mounted device defined in claim 2, wherein the rigid frame includes additional portions that extend along additional peripheral edges of the light-shielding structure and wherein the elastomer layer extends between the additional portions of the rigid frame.

4. The head-mounted device defined in claim 2, wherein the rigid frame includes an additional portion that extends from the portion of the rigid frame along a central portion of the light-shielding structure and wherein the elastomer layer includes portions that extend from the rigid frame toward the opposing edge of the light-shielding structure on opposing sides of the central portion.

5. The head-mounted device defined in claim 2, wherein the fabric cover comprises an opaque fabric cover.

6. The head-mounted device defined in claim 2, wherein the elastomer layer defines an opening configured to receive a nose.

7. The head-mounted device defined in claim 6, wherein the elastomer layer is configured to deform based on an outline of the nose.

8. The head-mounted device defined in claim 1, wherein the rigid frame and the elastic structure form an underlying structure over which the fabric cover is tented.

9. The head-mounted device defined in claim 1, wherein the rigid frame and the elastic structure define a non-overlapping layer over which the fabric cover is tented.

10. The head-mounted device defined in claim 1, wherein the elastic structure comprises a flexible arm that extends from the rigid frame and an elastic cord that extends through the flexible arm and has opposing ends coupled to the rigid frame.

11. The head-mounted device defined in claim 1, wherein the elastic structure comprises an additional fabric having a stretchy region surrounded by a structural region that is stiffer than the stretchy region.

12. The head-mounted device defined in claim 1, wherein the rigid frame is formed from a portion of the housing.

13. The head-mounted device defined in claim 1, wherein the rigid frame is attached to the housing and wherein the light-shielding structure at least partly defines an outline of the eye boxes and is configured to block external environmental light from entering the eye boxes when the head-mounted device is worn.

14. A head-mounted device comprising:
a housing;
displays disposed in the housing and configured to display images to eye boxes; and
a nasal-region-mounted light-shielding structure with first and second opposing sides, wherein the nasal-region-mounted light-shielding structure includes a rigid structure at the first side that is coupled to the housing, a flexible structure that extends along the second side and is configured to define an adjustable opening that receives a nose, and a cover layer that covers the flexible structure.

15. The head-mounted device defined in claim 14, wherein the flexible structure comprises a polymer layer and the cover layer comprises an opaque fabric cover.

16. The head-mounted device defined in claim 14, wherein the nasal-region-mounted light-shielding structure has first and second opposing surfaces that connect the first side to the second side and wherein the cover layer extends across the first and second surfaces and around the second side.

17. The head-mounted device defined in claim 14, wherein the flexible structure comprises an elastic cord that is coupled to the rigid structure via a flexible arm.

18. A head-mounted device comprising:
a housing;
displays disposed in the housing and configured to display images to eye boxes; and
a fabric coupled to the housing and having a flexible region that is configured to deform to receive a nose.

19. The head-mounted device defined in claim 18, wherein the fabric comprises a flat knit fabric.

20. The head-mounted device defined in claim 18, wherein the fabric has a structural region that surrounds the flexible region and is stiffer than the flexible region.
